(19) United States
(12) Patent Application Publication
(10) Pub. No.: US 2008/0141164 A1
(43) Pub. Date: Jun. 12, 2008

(54) AUTOMATED CONTROL TEXT TRUNCATION DETECTION

(75) Inventor: Xue Yin Jiang, ShangHai (CN)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/609,860

(22) Filed: Dec. 12, 2006

(51) Int. Cl. G06F 3/048

(52) U.S. Cl. 715/786

(57) ABSTRACT

A computer readable media includes instructions for retrieving a list of references to user interface controls included in a user interface. For each user interface control, information associated with the font specified for the control is retrieved. Information associated with the control itself, for example, the size of a text area associated with the control is then retrieved. The string to be drawn in the control's text area is then retrieved, and the information associated with the font is sued to determine the required size of the text area. The actual size of the control's text are is compared with the size of the text area required for the current string. If the actual size is less than the required size, the text is truncated. If the actual size is greater than the required size, the text is not truncated.

### BACKGROUND

A typical user interface may include buttons, text panels, and other user interface controls. These controls may include one or more text areas intended to display a text message when the control is rendered. For example, a button control may include text to aid a user of the button in determining the function of the button. A button control on a World Wide Web shopping web site might include the text “Checkout” to indicate to a user that they should click on the button to complete a transaction.

Typical integrated development environments (IDEs) include tools to create user interfaces for applications, World Wide Web sites, and the like. An IDE may also include functionality to associate a resource file with user interface controls. A resource file may include, among other things, an identifier of the control and an associated text string to be displayed by the control. The IDE may compile or otherwise prepare the user interface for execution by associating the resource file data with one or more user interface controls. Once the resource file has been associated with the user interface controls, the user interface may be executed and the text associated with the control is retrieved from the resource file data and displayed.

A resource file may be created for one or more different spoken languages such that a foreign language resource file may be included and substituted for the original resource file. In this way, a user interface may be “localized” to a different language. However, the original layout of the user interface may be fixed in size such that a longer foreign language word may be truncated when the user interface is localized. The result of such text truncation may be that any text drawn outside of a control's text area may not be visible to a user.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A test tool application or process may retrieve a list of references to user interface controls included in a user interface. For each user interface control, the test tool first retrieves information associated with the font specified for the control. The test tool then retrieves information associated with the control itself, for example, the size of a text area associated with the control. The test tool may then retrieve the string to be drawn in the control's text area and use the font information to determine the required size of the text area. The test tool may then compare the actual size of the control's text area with the size required for the current string. If the actual size is less than the required size, the text is truncated. If the actual size is greater than the required size, the text is not truncated. The test tool may then determine if there are more controls to be checked.

In alternative embodiments, the method used by the test tool to retrieve the font information associated with a control may vary. For example, in a runtime environment the test tool application or process may obtain a reference to the runtime process. The test tool may then use the reference to insert executable instructions in to the runtime process. The test tool may then send a command to the executable instructions to retrieve the font information associated with a control under investigation. The executable instructions may then return the font information to the test tool.

In another alternative method for retrieving the font information, a test tool application or process may send an instruction for retrieving font information to a process in which the user interface is executing. The process may then return the font information to the test tool. Another alternative embodiment for retrieving the font information may be one in which a client process creates a network package including a query to determine the font information for a control under investigation. The test tool then sends the network package to the display server. The display server may then retrieve the font information associated with the control under investigation and return it to the test tool.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows an example of a computing device for implementing one or more embodiments of an automated control text truncation detection system.

FIG. 2 shows an example of an English-language string drawn in a user interface control and an example of a French-language string drawn in a user interface control.

FIG. 3 shows an example control text truncation detection method.

FIG. 4 shows an example method for retrieving the control and font information associated with a user interface control in a dynamic runtime environment.

FIG. 5 shows an alternative example method for retrieving the control and font information associated with a user interface control in a typical operating environment.

FIG. 6 shows an alternative example method for retrieving the control and font information associated with a user interface control in a Unix X Window environment.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a automated control text truncation detection system, the system described is provided as an example and not a limitation. As those skilled in the art will appreciate, the present examples are suitable for application in a variety of different types of automated control text truncation detection systems.

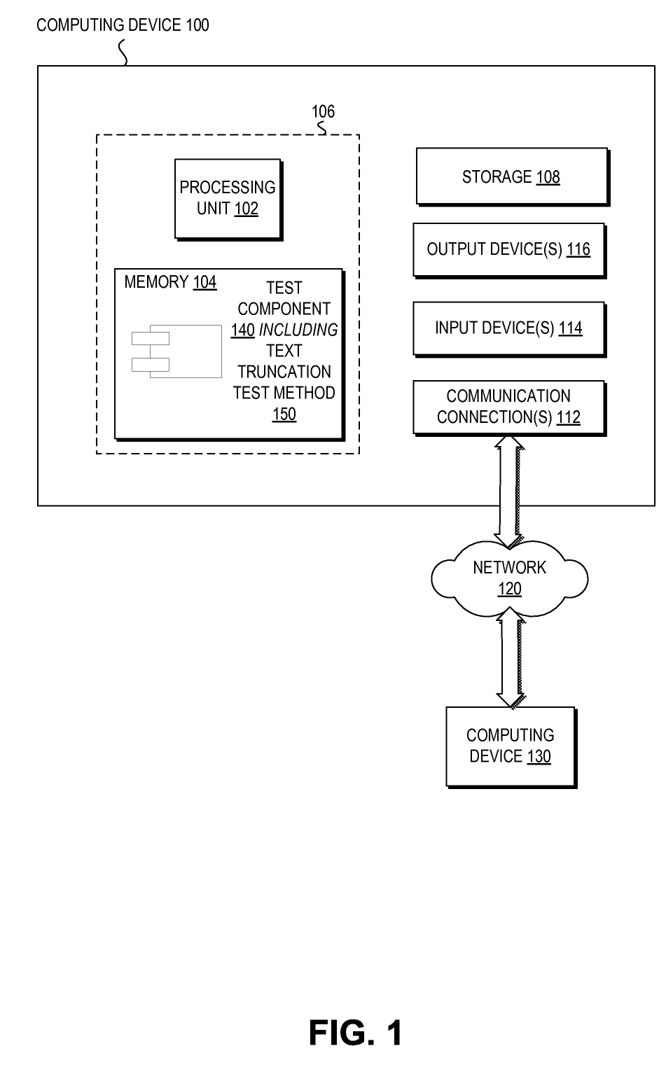

FIG. 1 and the following discussion are intended to provide a brief, general description of a suitable computing environment to implement embodiments of an automated control text truncation detection system. The operating environment of FIG. 1 is only one example of a suitable operating environment and is not intended to suggest any limitation as to the scope of use or functionality of the operating environment. Other well known computing devices, environments, and/or configurations that may be suitable for use with embodiments described herein include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments of the invention will be described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 1 shows an example of a computing device 100 for implementing one or more embodiments of an automated control text truncation detection system. In one configuration, the computing device 100 includes at least one processing unit 102 and memory 104. Depending on the exact configuration and type of computing device, memory 104 may be volatile (such as RAM), non-volatile (such as ROM, flash memory, etc.) or some combination of the two. In an alternative configuration 106, the processing unit 102 and memory 104 may be integrated such that a portion of the memory 104 may be included in the processing unit 102 in the form of a cache.

In other embodiments not illustrated in FIG. 1, the computing device 100 may include additional features and/or functionality. For example, the computing device 100 may also include additional storage (e.g., removable and/or non-removable) including, but not limited to, magnetic storage, optical storage, and the like. Such additional storage is illustrated in FIG. 1 by storage 108. In one embodiment, computer readable instructions to implement embodiments of the invention may be stored in storage 108. The storage 108 may also store other computer readable instructions to implement an operating system, an application program, and the like.

The term “computer readable media” as used herein includes computer storage media. Computer storage media includes volatile and nonvolatile, removable and non-removable media implemented in any method or technology for storage of information such as computer readable instructions or other data. Memory 104 and storage 108 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by the computing device 100. Any such computer storage media may be part of the computing device 100.

The computing device 100 includes communication connection(s) 112 that allow device 100 to communicate with other devices. Communication connection(s) 112 may include, but is not limited to, a modem, a Network Interface Card (NIC), or other interfaces for connecting computing device 100 to other computing devices. Communication connection(s) 112 may include a wired connection or a wireless connection. Communication connection(s) 112 may transmit and/or receive communication media.

Communication media typically embodies computer readable instructions or other data in a “modulated data signal” such as a carrier wave or other transport mechanism and includes any information delivery media. The term “computer readable media” may include communication media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media.

The computing device 100 includes input device(s) 114 such as keyboard, mouse, pen, voice input device, touch input device, infra-red cameras, video input devices, and/or any other input device. Output device(s) 116 such as one or more displays, speakers, printers, and/or any other output device may also be included in the computing device 100. Input device(s) 114 and output device(s) 116 may be connected to the computing device 100 via a wired connection, wireless connection, or any combination thereof. In one embodiment, an input device or an output device from another computing device may be used as input device(s) 114 or output device(s) 116 for the computing device 100.

Components of the computing device 100 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment not illustrated in FIG. 1, components of the computing device 100 may be interconnected by a network. For example, memory 104 may be comprised of multiple physical memory units located in different physical locations interconnected by a network.

Those skilled in the art will realize that storage devices utilized to store computer readable instructions may be distributed across a network. For example, another computing device 130 accessible via network 120 may store computer readable instructions to implement one or more embodiments of the invention. The computing device 100 may access computing device 130 and download a part or all of the computer readable instructions for execution. Alternatively, the computing device 100 may download pieces of the computer readable instructions, as needed, or some instructions may be executed at the computing device 100 and some instructions may be executed at the computing device 130. Those skilled in the art will also realize that all or a portion of the computer readable instructions may be carried out by a dedicated circuit, such as a Digital Signal Processor (DSP), programmable logic array, and the like.

Turning now to the test component 140, a test component 140 may include computer readable instructions to implement the test component 140 as a component such as a dynamic link library (DLL), a standalone test application, and the like. The test component 140 is illustrated in FIG. 1 as residing in memory 104 as computer readable instructions; however, the test component 140 may be executed by the processing unit 102 by any typical means of reading and executing computer readable instructions as discussed earlier.

The test component 140 further implements a control text truncation test method 150 that determines whether a given string will be truncated when rendered in a user interface control's display text area. The control text truncation test method 150 retrieves a list of user interface controls to investigate, retrieves the control's font and layout information, determines the required size of the text area for the control, determines the actual size of the text area for the control, then compares the actual size and required size to determine if the text will be truncated.

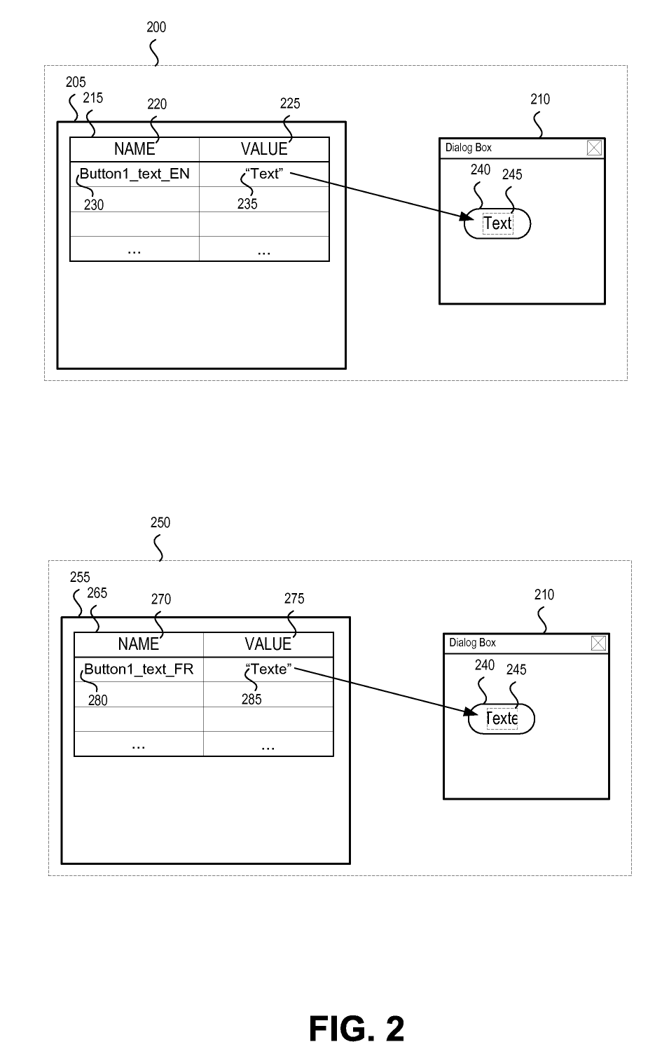

The cause of text truncation is further illustrated by the examples given in FIG. 2.

FIG. 2 shows an example of an English-language string drawn in a user interface control 200 and an example of a French-language string drawn in a user interface control 250.

In the example of an English-language string drawn in a user interface control 200, a user interface dialog box 210 includes a button control 240. The button control 240 includes a text area 245 where a string may be rendered in a particular font. Fonts are a single typeface stored in a computer readable form. A font typically includes an alphabet of letters, numbers, punctuation and other symbols, and the like. Some languages may be written logographically; that is, the language may be written such that one or more symbols may represent a single word or concept. Fonts for logographic languages may includes many hundreds or thousands of such symbols in addition to numbers, punctuation, and the like. Typically, a font includes standard spacing such that individual characters in the font include spacing to provide visual separation of the characters.

The example of an English-language string drawn in a user interface control 200 also includes an example resource file 205. The example resource file 205 includes a name-value table 215. The name-value table 215 further includes a name column 220 and a value column 225.example of an English-language string drawn in a user interface control 200 In this example, the name column 220 includes an identifier 230 to associate an English-language string 235 stored in the value column 225 with the button control 240.

In a typical integrated development environment (IDE) such as Microsoft Visual Studio™, a resource file such as the example resource file 205 may be associated with a user interface such as the user interface dialog box 210. The method of associating the resource file with a user interface may take any form; for example, the data in the resource file may be compiled into the computer readable instructions used to generate the user interface or the resource file may be included with a deployment of the user interface and the computer readable instructions used to generate the user interface may read the data from the resource file. In an alternative example, the data in the resource file may not be included in a file at all; such data may simply be compiled and stored in line with the computer readable instructions used to generate the user interface.

Furthermore, such an IDE may be used to specify one or more properties of a user interface control such as the height, width, position, and font characteristics such as font family or typeface, font size, style, and the like. Such properties may also be included in the computer readable instructions used to generate the user interface. When the user interface is executed, it is rendered using the properties specified in the IDE.

In the example of an English-language string drawn in a user interface control 200, the text area 245 is illustrated as being defined to contain the English word “Text” as contained in the English-language string 235. As the text area 245 has been defined to be large enough to display the English-language string 235, the word “Text” is fully visible in the button control 240.

Turning now to the example of a French-language string drawn in a user interface control 250, a similar example resource file 255 is illustrated as including a similar name-value table 265. The name-value table 265 is illustrated as including a similar name column 270 and a similar value column 275. As can be seen in this example resource file 255, the French-language string 285 associated with the identifier 280 is a French-language string “Texte”. Because the text area 245 was defined to be only large enough for the English-language string 235, it can be seen that the word “Texte” is truncated. In this example, the text is shown as being truncated on both the right and left sides, however, text may be truncated along any edge including multiple edges.

As can be seen, the substitution of a foreign language string in a control where the text area has been constrained to a particular size may result in truncation. The result of truncation may be that a user of the control may not read and understand the text displayed on the control.

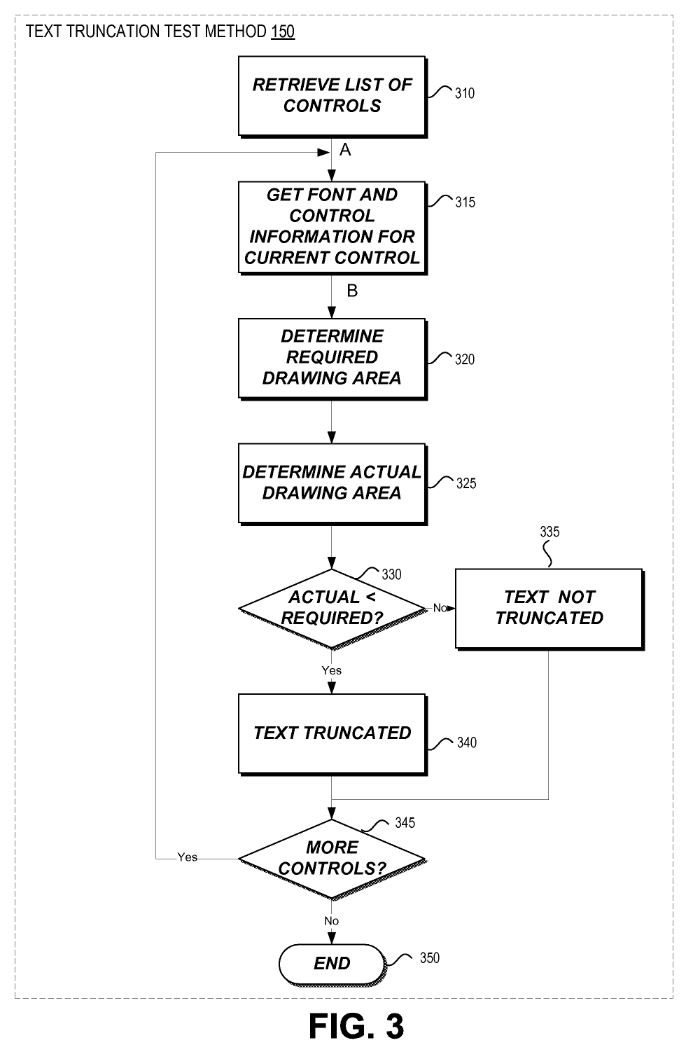

FIG. 3 shows an example control text truncation test method 150. The example control text truncation test method 150 and other flowcharts in this application may be implemented as computer readable instructions as discussed earlier in the description of FIG. 1, however, the control text truncation test method 150 may be implemented in any manner. The example control text truncation test method 150 may be performed using any string including text from any language.

Block 310 refers to an operation in which a list of references to user interface controls is retrieved from a user interface. The references may be any type of address or reference associated with a user interface control and may be retrieved using any method. For example, a user interface may include an array or list of user interface control handles. In another example implementation, only references to button controls, panel controls, radio button controls, and check box controls are retrieved.

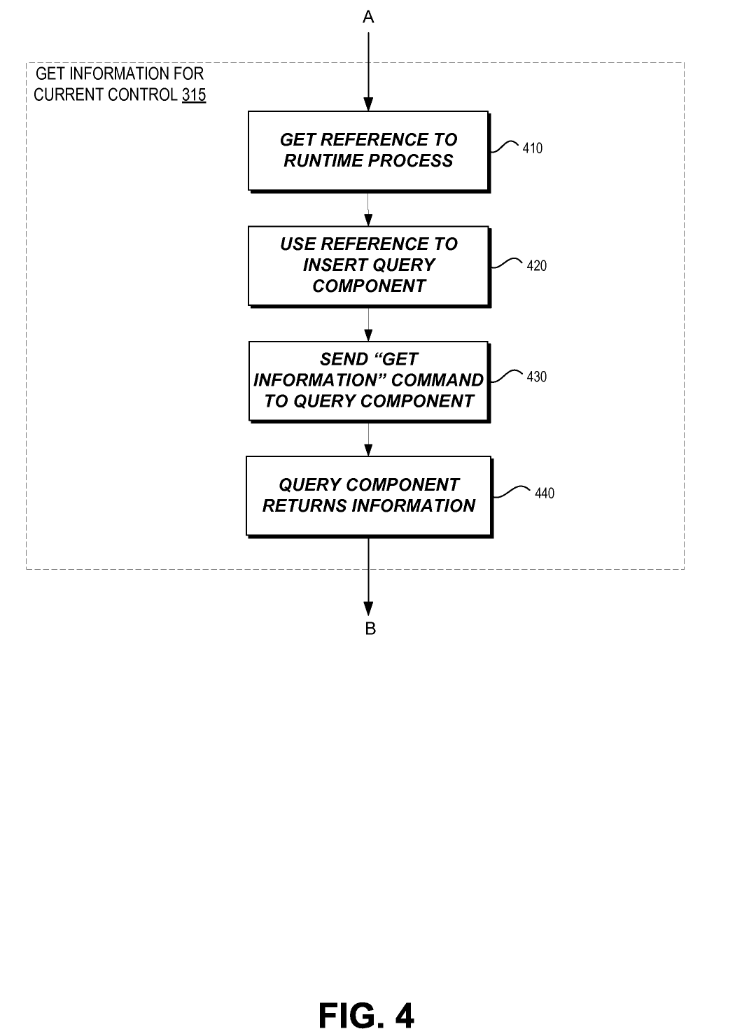

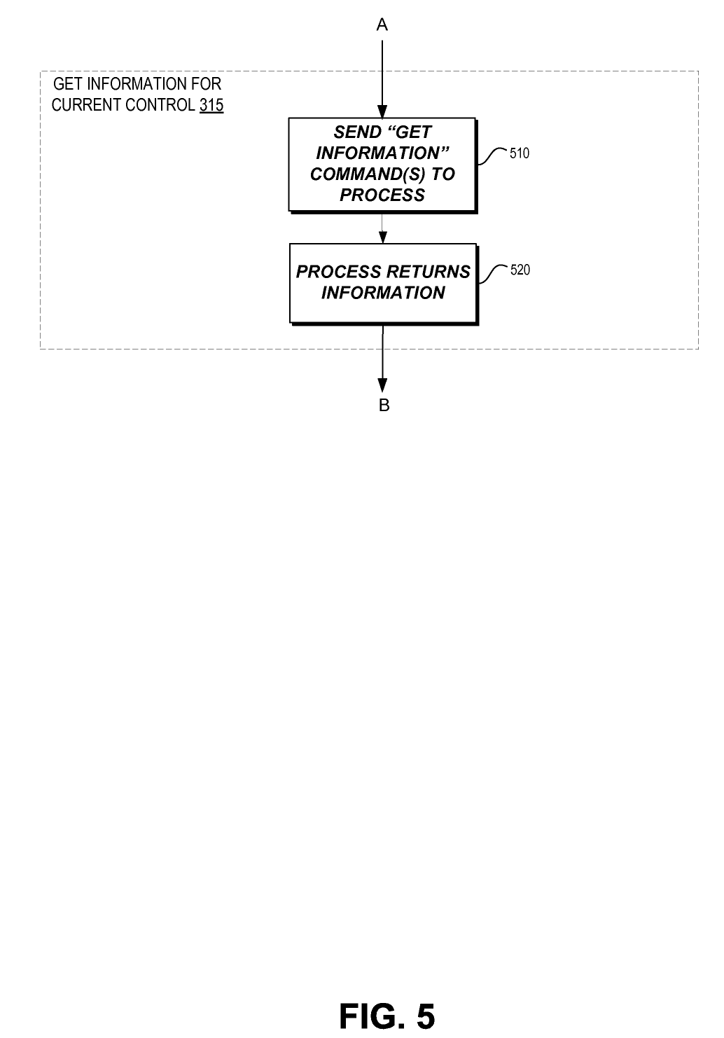

Block 315 refers to an operation in which the list of references to user interface controls is iterated and the font information and text area information for the current user interface control under investigation is retrieved. The font information and text information may be retrieved using any method; however, a number of example implementations are described in FIG. 3, FIG. 4, and FIG. 5. The font information retrieved may include the font name, any styles applied to the font, the font's size, kerning information, and the like. The control information retrieved may include the type of control, the size of the text area associated with the control, the margin or white space within the text area, and the like.

Block 320 refers to an operation in which the size of a polygon required for the string under investigation to be drawn is determined. Such a determination may be accomplished using any method; for example, the size of the characters in the font may be multiplied by the number of characters in the string and the result may be added to the necessary amount of margin white space.

Block 325 refers to an operation in which the actual size of the text area associated with the user interface control under investigation is determined. Such a determination may be accomplished using any method; for example, the user interface control information retrieved at block 315 may be queried.

Block 330 refers to an operation to determine if the size of the actual size of the text area associated with the user interface control under investigation is less than the size of the polygon required to draw the text string under investigation determined at block 320. Such a determination may be accomplished using any method; for example, the height of the polygons may be compared and the widths of the polygons may be compared. In response to a positive determination, flow continues to block 335. In response to a negative determination, flow continues to block 340.

Block 335 refers to an operation in which it has been determined that the string under investigation will not be truncated. Such information may be recorded in computer readable memory for future reporting or retrieval.

Block 340 refers to an operation in which it has been determined that the string under investigation will be truncated. Such information may be recorded in computer readable memory for future reporting or retrieval.

Block 345 refers to an operation to determine if there are more controls and/or more strings to be investigated. In response to a positive determination, flow continues back to block 315. In response to a negative determination, flow continues to block 350.

Block 350 refers to an operation in which the control text truncation test method 150 is terminated.

FIG. 4 shows an example method 315 for retrieving the control and font information associated with a user interface control in a dynamic runtime environment. A dynamic runtime environment may include computer readable instructions for executing a virtual computer processing environment. Computer readable instructions may be created that may be compiled and/or executed by the dynamic runtime environment. An example of a dynamic runtime environment is the Microsoft®.Net Frameworks™. Flow enters the example method 315 from point “A” of FIG. 3.

Block 410 may refer to an operation in which a reference to the runtime process is retrieved. The reference may be retrieved using any method; for example, the dynamic runtime environment may be located in computer readable memory and a reference may be determined. In another example, a computer operating system may include information regarding the dynamic runtime environment and may return the reference. In another example, the runtime environment itself may return the reference.

Block 420 refers to an operation in which the reference is used to insert a query component into the dynamic runtime process. The query component includes computer readable instructions to retrieve font and control information from a user interface executing within the dynamic runtime process. The query component may be any type of computer readable instructions, for example, a dynamic link library or assembly. Once the query component has been inserted into the dynamic runtime process, the dynamic runtime process executes the computer readable instructions included in the query component.

Block 430 refers to an operation in which a “get information” command is sent to the query component. Such a “get information” command is illustrative only and is not intended to explicitly represent the computer readable instructions sent to the query component. The “get information” command may be a single computer readable instruction or a multiple set of computer readable instructions intended to retrieve the font and control information associated with the control under investigation.

Block 440 refers to an operation in which the query component returns the collected information. Flow returns to point “B” in FIG. 3.

FIG. 5 shows an alternative example method 315 for retrieving the control and font information associated with a user interface control in a typical operating environment. A typical operation environment may be Microsoft® Windows™. Flow enters the example method 315 from point “A” of FIG. 3.

Block 510 refers to an operation in which a “get information” command is sent to a process executing the user interface including the controls under investigation. The process may be a typical computer process executing in an operating environment such as a computer application or dynamic link library. Such a “get information” command is illustrative only and is not intended to explicitly represent the computer readable instructions sent to the process. The “get information” command may be a single computer readable instruction or a multiple set of computer readable instructions intended to retrieve the font and control information associated with the control under investigation.

Block 520 refers to an operation in which the process returns the font and control information. Flow returns to point “B” in FIG. 3.

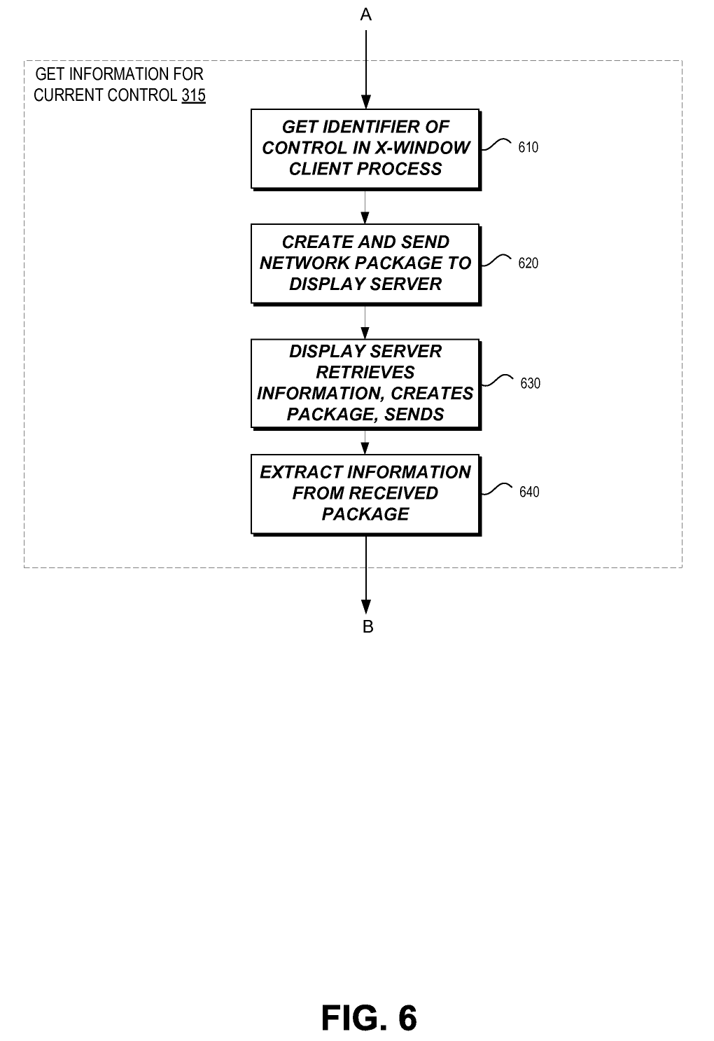

FIG. 6 shows an alternative example method 315 for retrieving the control and font information associated with a user interface control in a Unix X Window environment. The Unix X Window environment or system is a networking and display protocol that provides graphical windows services to Unix or Unix-like operating systems. An example of a Unix X Window environment is XFree86. Flow enters the example method 315 from point “A” of FIG. 3.

Block 610 refers to an operation in which an identifier of an X Window user interface control executing in a client process is retrieved. The identifier may be retrieved using any method.

Block 620 refers to an operation in which a network package following the X Window protocol standard is created. The contents of the network package include a query for the specific information of the user interface control under investigation. The query may further include the identifier retrieved at block 610.

Block 630 refers to an operation in which the display server receives the network package created at block 620. The display server may then retrieve the user interface control's font and control information from computer readable memory managed by the display server. The display server may then create a response network package included the requested font and control information and return it.

Block 640 refers to an operation in which the response network package is received from the display server. The requested font and control information is then extracted from the response package. Flow returns to point “B” in FIG. 3.

1. One or more computer readable media with computer executable instructions for performing steps comprising:
retrieving a reference to a user interface control;
retrieving one or more properties associated with a text area associated with the user interface control;
retrieving one or more properties associated with a font used to draw text in the text area;
determining a size of a polygon required to draw a text string using the font;
determining a size of the text area associated with the user interface control; and
comparing the size of the polygon and the text area.

2. The one or more computer readable media of claim 1, wherein retrieving one or more properties associated with the text area further comprises:
retrieving a reference to a runtime process;
sending a query component to the runtime process using the reference;
sending a command to the query component to retrieve the one or more properties associated with the text area; and
retrieving the one or more properties associated with the text area from the query component.

3. The one or more computer readable media of claim 1, wherein retrieving one or more properties associated with the font used to draw text in the text area further comprises:
retrieving a reference to a runtime process;
sending a query component to the runtime process using the reference;
sending a command to the query component to retrieve the one or more properties associated with the font used to draw text in the text area; and
retrieving the one or from the query component.

4. The one or more computer readable media of claim 1, wherein retrieving one or more properties associated with the text area further comprises:
retrieving an identifier of the user interface control in an X Window client process;
creating a network package including the identifier and instructions to return the one or more properties associated with the text area;
sending the network package to a display server;
receiving a network package including the one or more properties associated with the text area from the display server; and
extracting the one or more properties associated with the text area from the network package.

5. The one or more computer readable media of claim 1, wherein retrieving one or more properties associated with the font used to draw text in the text area further comprises:
retrieving an identifier of the user interface control in an X Window client process;
creating a network package including the identifier and instructions to return the one or more properties associated with the font;
sending the network package to a display server;
receiving a network package including the one or more properties associated with the font from the display server; and
extracting the one or more properties associated with the font from the network package.

6. The one or more computer readable media of claim 1, further comprising:
determining that the text string is truncated in response to the result of the comparison showing the polygon is larger than the text area.

7. The one or more computer readable media of claim 1, further comprising:
determining that the text string is not truncated in response to the result of the comparison showing that the polygon is smaller than the text area.

8. The one or more computer readable media of claim 1, wherein the user interface control is a button.

9. The one or more computer readable media of claim 1, wherein the user interface control is a text label.

10. The one or more computer readable media of claim 1, wherein the user interface control is a radio button.

11. The one or more computer readable media of claim 1, wherein the user interface control is a check box.

12. A user interface control text truncation test system, comprising:
a test component module, and
a process for testing user interface control text truncation executing in the test component, the process configured to retrieve a reference to the user control, retrieve information corresponding to a text area associated with the user control, retrieve information corresponding to a font associate with the text area, determine a required size of a polygon to draw a string using the font, determine an actual size of the text area, and comparing the actual size with the required size.

13. The user interface control text truncation test system of claim 12, wherein the test component module is further configured to retrieve a list of user interface controls.

14. The user interface control text truncation test system of claim 12, wherein the user interface control executes in a runtime environment.

15. The user interface control text truncation test system of claim 12, wherein the user interface control executes in a Unix X Windows environment.

16. The user interface control text truncation test system of claim 12, wherein the user interface control executes in a Windows environment.

17. The user interface control text truncation test system of claim 12, wherein the string is stored in a resource file.

18. The user interface control text truncation test system of claim 12, wherein the string is stored in line with the user interface control.

19. A user interface control text truncation test application, comprising:
a first retrieving component configured to retrieve a reference to a user interface control;
a second retrieving component configured to retrieve one or more properties associated with a text area included in the user interface control and one or more properties associated with a font associated with the text area; and
a determining component configured to compare a size required to a draw a string in the text area using the font and the actual size of the text area.

20. The user interface text truncation test application of claim 19, further comprising a reporting component configured to report that the string is truncated if the determining component comparison determines that the size required to draw the string in the text area is lesser than the actual size of the text area.
